(19) United States
(12) Patent Application Publication
(10) Pub. No.: US 2024/0420216 A1
(43) Pub. Date: Dec. 19, 2024

(54) SYSTEM FOR RECOMMENDING ITEMS AND ITEM DESIGNS BASED ON AI GENERATED IMAGES

(71) Applicant: Target Brands, Inc., Minneapolis, MN (US)

(72) Inventors: Brian STANKIEWICZ, St. Paul, MN (US); Brad Stuart THOMPSON, St. Paul, MN (US)

(21) Appl. No.: 18/742,801

(22) Filed: Jun. 13, 2024

Related U.S. Application Data
(60) Provisional application No. 63/507,779, filed on Jun. 13, 2023.

(51) Int. Cl. G06Q 30/0601; G06V 10/74; G06V 10/762

(52) U.S. Cl. CPC G06Q 30/0631; G06Q 30/0621; G06Q 30/0629; G06V 10/761; G06V 10/762

(57) ABSTRACT

A system that utilizes an AI image generator, a search engine, and an item design system is disclosed. A text description of an item is provided to an AI image generator, which creates an image based on the text description. In some embodiments, the image is updated based on a further text description of the item. The image may be provided to the search engine and the item design system. The search engine selects, from an item catalog, an item to recommend to a user based on a similarity of the image to items in the item catalog. For example, the search engine may apply a machine learning model to compare embeddings of the item image to embeddings of images of items in an item catalog. The item design system may recommend an item design based in part on the image generated by the AI image generator.

### CROSS-REFERENCE TO RELATED APPLICATIONS

The present application claims priority from U.S. Provisional Patent Application No. 63/507,779, filed on Jun. 13, 2023, the disclosure of which is hereby incorporated in its entirety.

### BACKGROUND

A search engine may receive a query and compare the query to existing data, such as a collection of records. Based on a similarity between the query and one or more of the records, the search engine may return one or more records. In the retail context, for example, a user may input a query to search for an item offered for sale via the retailer. A search engine may receive the query and compare it to data for a collection of items. For example, the search engine may match the text-based query to titles, descriptions, or categories of items. If the search engine finds a match between the query and an item, the search engine may return the item. However, in some instances, the search engine fails to return an item that the user wants. For example, the user's query may not adequately describe the item sought by the user, or the search engine may not retrieve items that best match the user's query.

### SUMMARY

Aspects of the present disclosure relate to a system that includes an artificial intelligence (AI) image generator, a search engine, and an item design system. The AI image generator creates an image based on a user description of an item. The image is provided to the search engine and the item design system. The search engine recommends an item to the user based on the image. The item design system recommends an item design based on the image.

In a first aspect, a method for using artificial intelligence (AI)-generated images to search an item catalog is disclosed. The method comprises providing a text description of an item to an application programming interface (API) of an AI image generator to generate an item image; receiving the item image from the AI image generator; applying a machine learning model to the item image to generate embeddings for the item image; generating a plurality of similarity scores by comparing the embeddings for the item image to a plurality of pre-computed embeddings derived from a plurality of images of items in the item catalog; based on the plurality of similarity scores, selecting a similar image from the plurality of images; and from the item catalog, selecting an item corresponding to the similar image.

In a second aspect, a system for using artificial intelligence (AI)-generated images to search an item catalog is disclosed. The system comprises a processor; and memory storing instructions that, when executed by the processor, cause the system to: provide a text description of an item to an application programming interface (API) of an AI image generator to generate an item image; receive the item image from the AI image generator; provide the item image to an item design system; apply a machine learning model to compare the item image to a plurality of images of items in the item catalog; from the plurality of images of items in the item catalog, identify a similar image to the item image; from the item catalog, select an item corresponding to the similar image; and provide data corresponding to the selected item to a user.

In a third aspect, a website including an item search feature is disclosed. The website comprises a processor; and memory storing instructions that, when executed by the processor, cause the website to: receive a text description of an item via a text input field of a user interface; provide the text description to an AI image generator to generate an item image; receive the item image from the AI image generator; apply a machine learning model to the item image to generate embeddings for the item image; generate a plurality of similarity scores by comparing the embeddings for the item image to a plurality of pre-computed embeddings derived from a plurality of images of items in the item catalog; based on the plurality of similarity scores, select a similar image from the plurality of images; and from an item catalog, select an item corresponding to the similar image.

### BRIEF DESCRIPTION OF THE DRAWINGS

FIG. 1 illustrates a network environment in which aspects of the present disclosure may be implemented.

FIG. 2 illustrates example operations performed by aspects of the present disclosure.

FIG. 3 illustrates a block diagram of an example implementation of an item design system.

FIG. 4 illustrates a diagram of example data exchanges between aspects of the present disclosure.

FIG. 5 is a flowchart of a method that may be performed by a user.

FIG. 6 illustrates example communications between a user and an AI image generator.

FIG. 7 is a flowchart of an example method that may be performed by an item design system.

FIG. 8 is a flowchart of an example method that may be performed by a search engine.

FIG. 9 illustrates an example computing system with which aspects of the present disclosure may be implemented.

### DETAILED DESCRIPTION

As briefly described above, aspects of the present disclosure relate to a system that includes a generative artificial intelligence (AI) service that generates images based on user text input. To search for an item, a user may input a description to the generative AI, which may generate an image based on the user's description. For example, a user may input the following description: “office chair with adjustable height.” Once the generative AI creates one or more images based on this description, the user may adjust the description. For example, the user may input the following: “with wheels, no arms, and in black.” The generative AI may then generate one or more new images based on the updated description. The user may iteratively update the image until the user is satisfied that an image generated by the AI is sufficiently similar to an item sought by the user.

In example aspects, the user may provide the image to a search engine and to an item design system. The search engine may compare the image to a collection of images from a catalog. Based on image similarity, the search engine may return one or more items that most resemble the image input by the user.

In example aspects, the item design system may receive the image and the descriptions used to generate the image. The item design system may receive images and descriptions from a plurality of users that use the generative AI to generate images. As a result, the item design system may have access to a plurality of images that represent items generated based on descriptions of what users are seeking. The item design system may use these images to identify demand trends. To do so, the item design system may cluster the images. Additionally, the item design system may apply attribute-based forecasting to the generated images and the descriptions. Furthermore, the item design system may rank one or more of the clusters or attribute groups. As a result, the item design system may identify types of items sought by users, and the item design system may generate an item design recommendation and provide the recommendation to a retailer or vendor.

Advantageously, aspects of the present disclosure allow a user to leverage an AI image generator as part of searching for an item. For example, by using text-to-image generation and an image-to-image comparison, aspects of the present disclosure enable a multi-part, multi-modal search for an item across a catalog of items, thereby leveraging item image data in a catalog of items when searching for items, as opposed to only text data, as is done in some previous search engine technology. As such, more accurate and nuanced searching, which may leverage more available data than text-only searches, may be achieved. Yet still, by enabling a user to iteratively refine an image that represents a sought-after product by using successive text strings to update an AI-generated image, aspects of the present disclosure may expand the degree to which a user can customize search data (e.g., a search image), which may in turn generate more accurate search results.

Thus, in some instances, if the user has difficulty describing an item, the user may instead use an image as a search input. Such an input may result in search results that better match what a user is seeking and that are more likely to result in a purchase. Furthermore, images of items generated by an AI image generator, which are generated in response to user text queries, may be used to identify new item design opportunities, because the images are created in part by users themselves, thereby signaling interest for such designs.

Therefore, instead of speculating regarding user interests, by integrating an item design system with a search feature that enables users to create images of sought-after products, an item design system may, in some instances, automatically, efficiently, and accurately identify attributes and features of items that users want to find. Moreover, the item design system may have actual AI-generated images of such items that may be provided to downstream users, such as designers, vendors, or analysts. Yet still, the item design system may identify when users were unable to find the sought-after item in an existing catalog, thereby signaling an opportunity for a new design. These are only a few of the advantages offered by aspects of the present disclosure.

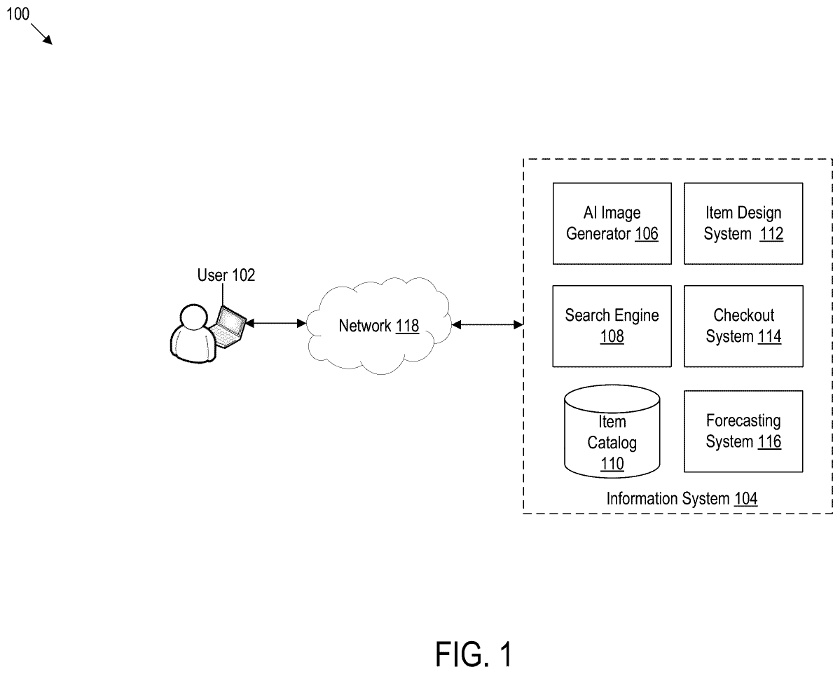

FIG. 1 illustrates an example network environment 100 in which aspects of the present disclosure may be implemented. In the example shown, the environment 100 includes a user 102 communicatively coupled with an information system 104 via the network 118.

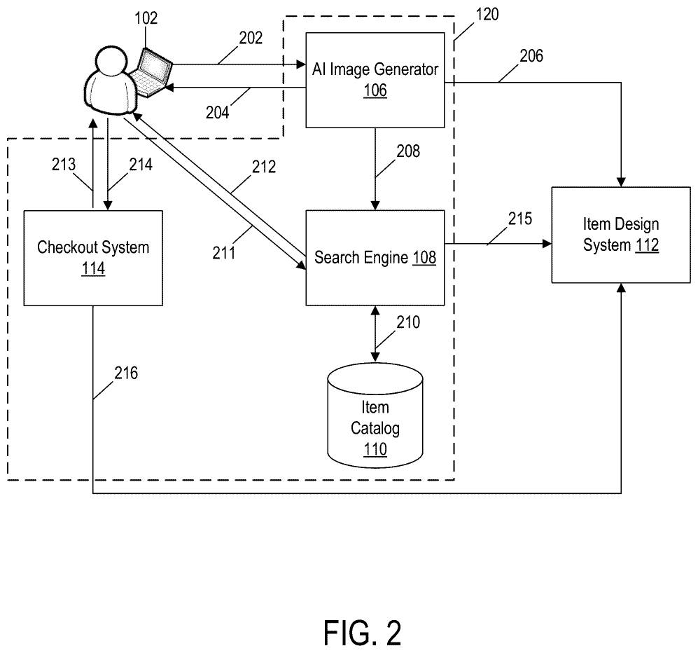

The user 102 may be a person that is searching for an item. For example, the user 102 may be a customer, or potential customer, of a retailer, vendor, or other business. In some embodiments, the user 102 may use a computing device to access the information system 104 over the network 118. The computing device may be, for example, a computer or a mobile device, such as a mobile phone or virtual reality headset. To access the information system 104, the user 102 may use a browser running on the computing device, or the user 102 may use a browser or mobile application that is associated with the retail platform. Although the example of FIG. 1 illustrates a single user 102, there may be a plurality of users that access the information system 104 and that perform operations that are described herein as performed by the user 102. Example operations that may be performed by the user 102 are described below in connection with FIGS. 2 and 5-6.

The information system 104 may be a collection of software, hardware, and networks. The information system 104 may be associated with an organization. For example, the organization may use, develop, maintain, own, or otherwise be associated with the components of the information system 104. In some embodiments, the information system 104 is associated with a retailer. The information system 104 may include one or more frontend systems via which the user 102 may interact with the information system 104. The frontend systems may include a website or a mobile application and may include user interfaces that are displayed on a browser or mobile application running on the user 102's computing device. Some components of the information system 104 may operate in a common computing environment. Some components of the information system 104 may operate in different computing environments and communicate over a network, such as the internet. Some components of the information system 104 may be developed and maintained by a third-party (e.g., an entity different than the organization with which the information system 104 is associated).

In the example of FIG. 1, the information system 104 includes an AI image generator 106, a search engine 108, an item catalog 110, an item design system 112, a checkout system 114, and a forecasting system 116. In other embodiments, the information system 104 may include more or fewer components.

The AI image generator 106 may be software program that receives, as an input, one or more of text or visual data and that outputs one or more images based on the input. For example, in some instances the AI image generator 106 receives a text query and generates an image based on the text query. In other instances, the AI image generator 106 may receive both text data and image data, and the AI image generator 106 may generate an image based on the text and image data. In some embodiments, the AI image generator 106 may use a machine learning model to generate images. In some embodiments, the AI image generator 106 may use a transformer architecture to convert text input into image features in a latent space and generate an image based on these features. In some embodiments, the image features are encoded as embeddings. In some embodiments, the AI image generator 106 may use a diffusion model to generate images. In some embodiments, the AI image generator 106 may use one or more variations of a deep neural network configured to receive one or more of text and image data to output image data.

In some embodiments, the AI image generator 106 may be developed, trained, and maintained by a third-party and may be accessed via an API, website, or other software program. In some embodiments, an application of the information system 104, such as a website or mobile application, may be an intermediary between the user 102 and the AI image generator 106. For instance, the user 102 may provide a text description to a retail website, which may provide the data to the AI image generator 106, and the image generated by the AI image generator 106 may be provided to the retail website, which may provide the image to the user 102. In examples, the AI image generator 106 uses one or more of DALL-E 2, NightCafe, Stable Diffusion, Midjourney, another image generation tool, or a service that implements aspects of an architecture underlying one or more these tools. In some embodiments, the user 102 may access the AI image generator 106 via a frontend system of the information system 104 and use the AI image generator 106 to generate images of items that the user 102 is seeking. When doing so, the user 102 may iteratively update the images generated by the AI image generator 106.

The search engine 108 may receive an input and, based on the input, select one or more items from a collection of items. The input may be an image, such as an image generated by the AI image generator 106. In examples, the search engine 108 may compare the image to images stored in the item catalog 110. The search engine 108 may execute a program for evaluating image similarity. The search engine 108 may use one or more of a plurality of potential image comparison techniques for evaluating image similarity. For example, the search engine 108 may compare the received image to a catalog of images based on one or more of key point detection and comparison, pixel similarity, machine learning models, another technique, or an ensemble of techniques. Regarding machine learning models, the search engine 108 may use embeddings to compare the item image to images of item in the item catalog 110. Embeddings may be a numerical representation of data, such as a vector of numbers that represent that query image or an image of an item in the item catalog 110.

In some embodiments, the search engine 108 may use a neural network to generate embeddings for the query image and then compare these generated embeddings against a plurality of embeddings for images in the item catalog 110. In some embodiments, the embeddings of images in the item catalog 110 may be pre-computed and may be derived from images in the item catalog 110 against which the search engine 108 compares the query image. For example, the pre-computed embeddings may have been determined prior to the determination of the embeddings for the query image.

In some embodiments, to derive the pre-computed embeddings, the same machine learning model used to generate embeddings for the query image may be used to generate embeddings for one or more images of one or more items in the item catalog 110. In some embodiments, the search engine 108, or another program, may use a machine learning model to periodically update the pre-computed embeddings for images of item in the item catalog 110, as images are updated and as the item catalog 110 is updated. As such, by using pre-computed embeddings, the search engine 108 may, in some instances, more quickly identify similar images than when the embeddings are not pre-computed.

The search engine 108 may then select and return an item having an image that is most similar to the input image. The measure of similarity may depend on the image comparison technique that is implemented. In the context of embeddings generated by machine learning models, similarity may be determined based on similarity scores. For example, similarity scores may be based on cosine similarity or Euclidean distance between embeddings for the query image and embeddings for images in the item catalog 110 in a latent space.

Although there may not be an identical image in the item catalog 110 to the image generated by the user 102 using the AI image generator 106, there may nevertheless be a most similar image. The search engine 108 may select an item from the item catalog 110 that corresponds to an image (or images) that have been determined to be most similar to the query image. In some embodiments, the search engine 108 may return a plurality of items based on their similarity with the input image.

Additionally, in some embodiments, the search engine 108 may also use text to select the one or more items. For example, the search engine 108 may match text input to textual data associated with items of the collection of items. In some embodiments, determining text similarity may be based at least in part on keyword matching. In some embodiments, determining text similarity may be based on similarity of text embeddings generated by a machine learning model for the query text and text associated with items in the item catalog 110. In some embodiments, the search engine 108 may select items from the item catalog 110 based on a weighted combination of visual similarity and textual similarity. In some embodiments, the search engine 108 may use a multi-modal machine learning model that uses both text and image data to identify similar items. As an example, the multi-modal machine learning model may map input text and image data onto a shared latent space and compare embeddings for the input text and image data to embeddings associated with items in the item catalog 110, which may also be mapped to the shared latent space.

The item catalog 110 may be a database storing data for a plurality of items. For each item of the plurality of items, the item catalog 110 may store one or more images and textual data, such as a title, description, or attributes. The item catalog 110 may hierarchically organize items. For example, items may be grouped by department, class, subgroup, or other granularity of classification. In some embodiments, the item catalog 110 may include items that are associated with a retailer, such as items offered for sale by the retailer. In some embodiments, the item catalog 110 may be updated as items are added, removed, or edited.

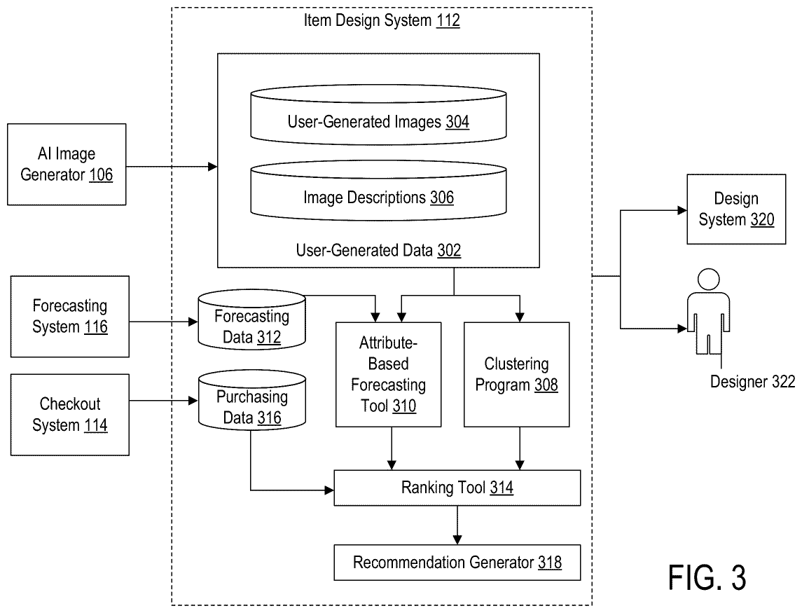

The item design system 112 may be used to design new or updated items. For example, the item design system 112 may receive images generated by the user 102 using the AI image generator 106. Using these images, the item design system 112 may generate recommendations related to new items or new item designs. To generate recommendations, the item design system 112 may analyze (e.g., by clustering images or by extracting and analyzing image attributes) the images generated by the AI image generator 106. Such an analysis may indicate that users are searching for items having certain attributes, given that the users are describing items having such attributes to the AI image generator 106. In addition to images, the item design system 112 may also use textual data input by users, user purchasing activity, forecasting data, or other information as part of generating recommendations related to item demand. In some embodiments, operations performed by the item design system 112 may be performed automatically. For example, in response to receiving a text description of an item and an item image based on that text description, an application of the information system 104 may automatically provide the item image to the item design system 112, which may automatically identify item attributes, perform a clustering operation, determine an attribute-based demand forecast, and determine whether to generate a new item design recommendation. Example components and operations of the item design system 112 are illustrated and described below in connection with FIG. 3.

The checkout system 114 may, among other things, track user purchases of items. For example, after the search engine 108 recommends an item to the user 102, the user 102 may decide whether to purchase the item. If the user 102 elects to do so, the user 102 may use the checkout system 114. The checkout system 114 may then communicate with other systems, such as a shipping, inventory, or payment system. Additionally, the checkout system 114 may provide purchase activity data to the item design system 112. As a result, the item design system 112 may have data indicating whether the items recommended by the search engine 108 were purchased or added to a cart.

The forecasting system 116 may forecast item demand. In some embodiments, the forecasting system 116 may forecast item demand broken down by one or more of an attribute (e.g., by item category, brand, seasonality, or other attribute), store location, geographical location, time period, or other metric. In some embodiments, the forecasting system 116 may use an ensemble of forecasting systems to project item demand. In some embodiments, the forecasts may be based at least in part on historical demand. Historical demand may be based at least in part on historical sales data. In some embodiments, the forecasting system 116 may provide item demand to the item design system 112, and forecasted item demand may be used to generate recommendations related to item demand.

The network 118 may be, for example, a wireless network, a wired network, a virtual network, the internet, or another type of network. The network 118 may be divided into subnetworks, and the subnetworks may be different types of networks or the same type of network. In different embodiments, the network environment 100 can include a different network configuration than shown in FIG. 1, and the network environment 100 may include more or fewer components than those illustrated.

FIG. 2 illustrates a schematic block diagram of aspects of the present disclosure. The block diagram of FIG. 2 illustrates example steps 202-216 that may be performed, for example, by components illustrated in FIGS. 1-2.

In the example shown, the user 102 may interact with a retail website 120, which is an example of a portion of information system 104 of FIG. 1. The user may, for example, enter search descriptions into a text input field, such as a text search interface of a retail website, for example to search for items available for sale within a retail enterprise's item catalog.

In the example shown, the user 102 may input a description into the AI image generator 106 (step 202). In some embodiments, the user 102 may access the AI image generator 106 via a frontend application of the information system 104, such as an application configured to facilitate searching for items (e.g., the retail website user interface). For instance, the user 102 may input the text description of the item into an item search feature of the frontend application, which may, in turn, provide the text description to the AI image generator 106, such as via an application programming interface (API) of the AI image generator 106. As another example, the frontend application may be an application for designing products. In some embodiments, the user 102 may interact with one or more of the AI image generator 106, search engine 108, or checkout system 114 via one or more APIs. The description input by the user 102 may be a string of text that describes an item for which the user 102 is searching. In some embodiments, the description may include free form text input by a user and structured text in the form of a selection of one or more categories or filters used when searching for items. In response to receiving the description, the AI image generator 106 may generate one or more images based on the description.

In the example shown, the AI image generator 106 may output the item image to the user 102 (step 204). In some embodiments, the AI image generator 106 may provide the image to a calling application (e.g., a frontend application of the information system 104), which may then provide the item image to the user 102. If the user 102 is satisfied that the image adequately depicts the item sought by the user 102, then the AI image generator 106 may proceed to the steps 206 and 208. If, on the other hand, the user 102 want to alter the image (e.g., because the user 102 determines that the image does not adequately depict the item sought by the user, or because the user 102 changes his or her mind), then the user 102 may input another description into the image generator 106, thereby returning to the step 202 to input one or more of text data or image data to generate a subsequent image using the AI image generator 106, a feature that may enable the user 102 to use the AI image generator 106 to iteratively refine an image that is to be used as an input to the search engine 108 and the new item design system 112.

In the example shown, the AI image generator 106 may output a generated image to the item design system 112 (step 206) and to the search engine 108 (step 208). In some embodiments, the AI image generator 106 may provide the item image to a calling application (e.g., a frontend application of the information system 104), which may provide the item image to one or more of the search engine 108 or the item design system 112. In addition to the image, the AI image generator 106 may also, in some embodiments, output the descriptions input by the user to one or more of the item design system 112 or the search engine 108. In some instances, the images generated by the AI image generator may be captured, and may be sent, optionally alongside the descriptions input by the user to that point, to the item design system 112 (step 206) without sending such information to the search engine. For example, such images may represent images of items that are considered insufficiently close in appearance to a desired item, and may represent negative examples of items, while searched items may represent positive examples of items considered desirable to the user.

In the example shown, the search engine 108 may compare the image received from the AI image generator 106 with images in the item catalog 110 (step 210). The search engine 108 may execute a program for determining image similarity. For example, the search engine 108 may perform a feature-based comparison that, for a pair of images, determines a numerical representation (e.g., a number from 0 to 99) of how similar the images arc.

In some embodiments, the search engine 108 may apply a computer vision algorithm to compare the AI-generated image to images from an item catalog to identify similar images and rank images by similarity. In some instances, a machine learning model (e.g., a convolutional neural network) may be applied to extract image features prior to comparing images. In some examples, the extracted image features may be represented as embeddings. For example, the image feature may be represented numerically, and a cosine similarity process may return a value representing degree of similarity or dissimilarity, which may be normalized and ranked to generate an overall similarity comparison score. Other approaches are possible as well, as described, for example, in connection with FIG. 1.

In some embodiments, the comparison may account for image rotations, reflections, and warping. In some embodiments, the search engine 108 may apply a pre-comparison step to improve the speed of image comparison. For example, the search engine 108 may determine a category of the received image and then compare the image to images in the item catalog from the determined category. In some embodiments, the search engine 108 may determine the one or more most similar images to the generated image and select the one or more items corresponding to those images. In some embodiments, the search engine 108 may determine that there are not any items with corresponding images that are sufficiently similar to the generated image. In such instances, the search engine 108 may, for example, alert the user 102 that the item could not be found, and the search engine 108 may, for example, provide data to the item design system 112 indicating that an item sought by a user was not found.

In some instances, the search engine 108 may use a combination of image-based similarity between the designated image from the AI image generator 106 and text input into the AI image generator in step 202. In some instances, the text may include an aggregate set of text input to arrive at the image that is generated (e.g., the one or more user search strings used to generate the image output to the search engine). The combination of image and text similarity may be performed in a variety of ways. For example, image similarity scores may be computed and weighted, and combined with weighted text similarity scores generated based on the combination of user text entries compared against item descriptions. The relative weighting of image and text similarity scores may be adjusted and tuned to achieve maximum likelihood if selection of an item returned from the search engine 108 based on historical user activity patterns.

In the example shown, the search engine 108 may provide the one or more selected items to the user 102 (step 212). For example, the one or more selected items may be presented to the user 102 via a results page of a retail website or mobile application. The search engine 108 may display one or more of a title, image, or description of the selected items. In some embodiments, the search engine 108 may log which items are recommended to the user 102. Having received the search results, the user 102 may interact with the returned items (step 211), for example selecting items to view an item detail page associated with an item returned by the search engine 108. User interactions with returned items in step 211 may be provided to the item design system (step 215) as reflecting interest in certain items included within the search results. Such information may include item selections as well as the searches and images that resulted in the items being returned.

In some instances, the user may interact with the retail website 120 by, e.g., electing whether to purchase one or more of the returned items. In the example shown, the user 102 may select one or more of the returned items (step 214). For example, the user 102 may add one or more of the items to a digital shopping cart, or purchase one or more of the items. The checkout system 114—or a component communicatively coupled with the checkout system 114—may capture and log the user's selection of the one or more items. For example, the checkout system 114 may log an identifier of the user 102 and which items were purchased (or added to a cart) by the user 102. As a result, the checkout system 114 may capture whether items recommended by the search engine 108 were, in fact, purchased by the user 102. Conversely, instances may be captured in which the search engine 108 recommends an item to the user 102, and the checkout system 114 does not log a purchase of the item. In some embodiments, instances may be captured in which the search engine 108 recommends an item to the user 102, and the user selects and views the items, but does not elect to add the item to their cart or purchase the item. Thus, successful recommendations (e.g., resulting in further user interaction, such as a purchase) and unsuccessful recommendations (e.g., not resulting in further user interaction, such as a purchase) may be captured.

In the example shown, the checkout system 114 may also provide data to the item design system 112. For example, the checkout system 114 may provide data indicating which item recommendations were successful and which item recommendations were unsuccessful. In other examples, other systems, such as the search engine 108, may capture data and provide that data to the item design system 112 regarding interactivity with recommended items.

It is noted that the various interactions between the retail website 120 and the item design system 112 are intended as examples, rather than limiting. A variety of types of interactions by the user 102 and any of the AI image generator 106, the search engine 108, the checkout system 114, and other types of interactions may reflect on the potential interest of the user in a particular item (e.g., a generic item not yet available at the retail website, or a particular item offered for sale). In general, a greater level of interaction and/or searching may represent more interest in a particular item or item type, and a greater number of interactions may represent a closeness between the generated image of an item and the item that user has in mind for purchase. As such, significant browsing activity related to a particular AI-generated image may indicate stronger interest in an item of that type, and the lack of a purchase may indicate a need for such an item. By contrast, little browsing related to an AI-generated image (e.g., images that are generated but for which the user elects to not conduct a search, or does not view any items of that type) indicate a potential lack of interest. Items actually purchased may indicate that, although there is interest in a particular item type, that interest is already met with an item available from the retailer's item catalog.

The item design system 112 may, in example embodiments, receive information from the AI image generator 106, search engine 108, checkout system 114, and/or other components of the retail website 120, and may assist in determining (or may automatically or autonomously determine) one or more items that are not currently included in an item catalog 110, but which may be obtained from a vendor and/or created so that they may be subsequently included in the item catalog 110, and eligible to be offered to the user 102.

FIG. 3 illustrates a block diagram of an example implementation of the item design system 112. The item design system 112 may receive data from other systems, such as the AI image generator 106, the forecasting system 116, and the checkout system 114, and based at least in part on the received data, the item design system 112 may output design recommendations to an item design system 320 (e.g., a program or system that facilitates new or updated items or designs) or a designer 322. In the example shown, the item design system 112 includes user-generated data 302, a clustering program 308, an attribute-based forecasting tool 310, forecasting data 312, a ranking tool 314, purchasing data 316, and a recommendation generator 318.

The user-generated data 302 may include data from users that interact with the information system 104. For example, the user-generated data 302 may include data input by the user 102 or data generated in response to an input by the user 102. In some embodiments, the item design system 112 may store the user-generated data 302 using one or more of a Hadoop cluster or a SQL database. In some embodiments, the user-generated data 302 includes user-generated images 304 and image descriptions 306.

The user-generated images 304 may include a collection of images generated by the AI image generator 106 in response to user descriptions. The user-generated images 304 may include images generated in response to descriptions from a plurality of users. In some embodiments, once a user, or an application of the information system 104, sends an image to the search engine 108, then the image may also be stored in the user-generated images 304. In some embodiments, the user-generated images 304 may also include images that were further edited by a user prior to sending a query to the search engine 108. In some embodiments, the user-generated images 304 may also include metadata, such as an identifier of the user that generated the image, an identifier of the image generator program that created the image, a timestamp, a location, an image category, or other data.

The image descriptions 306 may include a collection of image descriptions that are text strings input by users to generate images. Each of the text strings may be associated with one or more images in the user-generated images 304. For example, a user may input the description, “mesh baseball cap with Team X and Team Y logo,” and the AI Image generator 106 may generate an image of such a baseball cap. The description of the baseball cap may be stored in the image descriptions 306, the image of the baseball cap may be stored in user-generated images 304, and there may be data stored (e.g., as metadata or in a mapping database) that links the stored description with the stored image.

The user-generated data 302 may be provided to downstream systems for analysis. The downstream systems may, for example, analyze the user-generated data 302 to identify trends in user demand or to identify new item or design opportunities. In the example shown, the user-generated data 302 may be provided to the clustering program 308 and the attribute-based forecasting tool 310.

The clustering program 308 may receive user-generated data, cluster the user-generated data, and output clusters indicative of user interest and item attributes. In some embodiments, the clustering program 308 may receive a plurality of images from the user-generated images 304, and the clustering program 308 may cluster images of the plurality of images based on similarity. To do so, the clustering program 308 may extract image features and then perform a clustering process using the image features. To extract image features, the clustering program may, in some embodiments, use a convolutional neural network. The clustering process may include executing a supervised, semi-supervised, or unsupervised machine learning algorithm. In some embodiments, the clustering program 308 may, prior to clustering images, select images based on category (e.g., “furniture”, “clothing”, “food,” etc.) and then cluster the selected images into a plurality of clusters within that category. In some embodiments, the clustering program 308 may take a multi-modal approach and cluster data by using both images from the user-generated images 304 and the images' linked descriptions in the image descriptions 306. As items and related descriptions are added to a particular cluster, the concentration of items within a cluster may indicate relative interest in a particular product, while an overlay of item selection data (e.g., searches, item views, adds to cart, purchases of existing items) may be used to indicate interest in a new product (as compared to an existing product) as described above. Such past interactions may be used to inform a forecast for a new item, as discussed below.

In some instances, each cluster may be generated based on images and associated linked descriptions (e.g., full search strings), and those which are searched are associated with potential user interest, while intermediate images and related search strings may be clustered into groups of items indicating a lack of interest. As such, particular attributes may be further isolated as to their influence on desirability of a particular item design.

The attribute-based forecasting tool 310 may receive user-generated data 302 and forecasting data 312. In some embodiments, the attribute-based forecasting tool 310 may also receive purchasing data 316. The attribute-based forecasting tool 310 may extract attributes from one or more of the images or descriptions of the user-generated data 302. To do so, the attribute-based forecasting tool 310 may, for example, use text data that was input by users to generate images. For example, if a user description to generate an image includes the word “hat,” then the attribute-based forecasting tool 310 may determine that an attribute of the image that was generated is that the image portrays a hat. In some embodiments, a named entity recognition task may be performed by the attribute-based forecasting tool 310 to extract attributes from user descriptions. In some embodiments, the attribute-based forecasting tool 310 may use visual features of an image to identify its attributes. For example, the attribute-based forecasting tool 310 may apply a computer vision algorithm to recognize and classify objects within images or to classify an image in its entirety to determine attributes for the image. In some embodiments, the attribute-based forecasting tool 310 may use a combination of text and visual data to identify item attributes.

Furthermore, the attribute-based forecasting tool 310 may compare the user-generated data 302 (e.g., attributes extracted from the user-generated data 302) with the forecasting data 312 that may be output by the forecasting system 116. By doing so, the attribute-based forecasting tool 310 may determine forecasted demand for items having particular attributes that are sought by users, such as the user 102. As an example, an image generated by the AI image generator 106 in response to a user query may be a “mesh baseball cap with the logo of team X.” The attribute-based forecasting tool 310 may determine that that such an image has the attributes of “apparel,” “hat,” and “Team X.” Then, forecasted demand for items having one or more of these attributes may be retrieved from the forecasting data 312. Furthermore, in some embodiments, the item design system 112, or another component of the information system 104, may provide updates to the forecasting system 116 based on image descriptions input by the user 102 or images generated by the AI image generator 106, as such data may be indicative of user demand.

In some embodiments, one or more of the clustering program 308 or the attribute-based forecasting tool 310 may combine attributes from different user-generated images 304 and different image descriptions 306. For example, the attribute-based forecasting tool 310 may identify a first attribute associated with one or more user-generated images (e.g., the first attribute may be a cooler that has built-in dividers) and a second attribute associated with one or more other user-generated images (e.g., the second attribute may be a cooler attached to a grill). The attribute-based forecasting tool 310 (or another component of the item design system 112) may combine such attributes (e.g., a cooler attached to a grill and having built-in dividers). The attribute-based forecasting tool 310 may also, in some embodiments, determine a forecast for an item with the combined attributes, and then provide data associated with the collection of attributes and the demand forecast to the ranking tool 314 or the recommendation generator 318. As such, the attribute-based forecasting tool 310 may selectively aggregate features from the user-generated data 302 to generate a collection of attributes for a new item, determine a forecasted demand for such an item, and provide the collection of attributes to the ranking tool 314 or recommendation generator 318 to evaluate whether to generate a recommendation for an item having the collection of attributes.

The ranking tool 314 may receive data from one or more of the clustering program 308, the attribute-based forecasting tool 310, or the purchasing data 316. For example, the ranking tool 314 may receive attribute-based forecast data from the attribute-based forecasting tool 310. Using such data, the ranking tool 314 may rank which attributes or items present the greatest opportunity for a new design or item. As another example, the ranking tool 314 may receive a plurality of item clusters from the clustering program 308, and the ranking tool 314 may rank the clusters based on a characteristic of the clusters. For example, the ranking tool 314 may rank the clusters based on a number of items in each cluster or a similarity of items within a cluster. Furthermore, the ranking tool 314 may rank clusters based on data that is common to the items in the clusters. For example, a cluster of items with images that were selected by a user 102 to submit to the search engine 108 may be ranked higher than a cluster of items that were further refined by the user 102. Furthermore, the ranking tool may also consider other factors, such as costs, sales prices, design and manufacturing feasibility, the forecasting data 312, the purchasing data 316, or other considerations.

Additionally, in some embodiments, the ranking tool 314 may combine data from the attribute-based forecasting tool 310 and the clustering program 308 to rank items. Furthermore, the ranking tool may also consider other factors, such as costs, sales prices, design and manufacturing feasibility, the forecasting data 312, the purchasing data 316, or other considerations.

The purchasing data 316 may include user activity data that is captured by the checkout system 114 and/or search engine 108. For example, the purchasing data 316 may include a plurality of instances of recommended items (e.g., recommended by the search engine 108) and whether the item was purchased by the user to whom the item was recommended, or whether the item was viewed by the user. Such data may be used by the ranking tool 314. For example, if a type or category of item has a low success rate (e.g., having fewer recommendations that result in purchases), then the ranking tool 314 may increase the ranking of data related to that type or category, as the low success rate may indicate that users are searching for a type of item but are not being recommended items that they want to purchase, a sign that there may be an opportunity for a new item or design. In other embodiments, the ranking tool 314, or another component of the item design system 112, may use the purchasing data 316 in a different manner.

In some embodiments, the ranking tool 314 may combine data from the attribute-based forecasting tool 310 and the clustering program 308 to rank items. For example, the ranking tool 314 may, for a given cluster, identify one or more attributes for items in that cluster and determine a demand forecast for items with these one or more attributes. Based on a combination of the demand forecast for these attributes and features of the cluster, such as a number of items in the cluster, purchasing data associated with items in the cluster, or another characteristic of items in the cluster, the ranking tool 314 may generate a score that represents an interest in items having the one or more attributes. The ranking tool 314 may then compare this score to scores derived in a similar manner for other attributes.

The recommendation generator 318 may receive data from other components of the item design system 112 (e.g., the ranking tool 314) and determine whether to generate a design recommendation. The design recommendation may include a recommendation to design a new item or to edit an existing item design. Additionally, in some embodiments, the recommendation may include one or more images from the user-generated images that are related to a type or category of item for which the item design system 112 has generated a recommendation. For example, if the item design system 112 identifies (based, for example, on forecast data, user-generated data, and clustering results) that there is a design opportunity for mesh baseball caps with certain features, then the recommendation to the design system 320 or designer 322 may include images generated by the AI image generator 106 of such baseball caps, descriptions of such baseball caps, forecast or purchasing data for such baseball caps, or other data received or generated by the item design system 112 for such baseball caps.

In some embodiments, the recommendation generator 318 may, prior to generating a recommendation, determine whether a metric for a potential design opportunity is greater than a threshold. For example, the recommendation generator 318 may determine whether there is sufficient forecasted demand (e.g., as measured by forecasted sales, profit, or another metric) or whether a sufficient number of users have described and had images generated for a potential design. If so, the recommendation generator 318 may generate a recommendation for the potential design and provide the recommendation to one or more of the design system 320 or the designer 322. If not, the recommendation generator 318 may not generate a recommendation for the potential design. In other embodiments, the recommendation generator 318 may use a different threshold metric in determining whether to generate a recommendation.

In some embodiments, the recommendation generator 318 may generate a recommendation that includes a combination of attributes. For example, based on data from one or more of the attribute-based forecasting tool 310 or the clustering program 308, the recommendation generator 318 may identify that there customer interest and potential demand for jeans having a certain color. Furthermore, the recommendation generator 318 may identify, based on data from one or more of the attribute-based forecasting tool 310 or the clustering program 308, that there is customer interest and potential demand for jeans having a certain cut. The recommendation generator 318 may combine the certain color with the certain cut to generate design recommendation for jeans that includes a combination of the attributes of interest. As such, new item designs may be recommended based on images generated by a plurality of different users who expressed interest in different yet compatible attributes while interacting with the AI image generator 106 or the search engine 108.

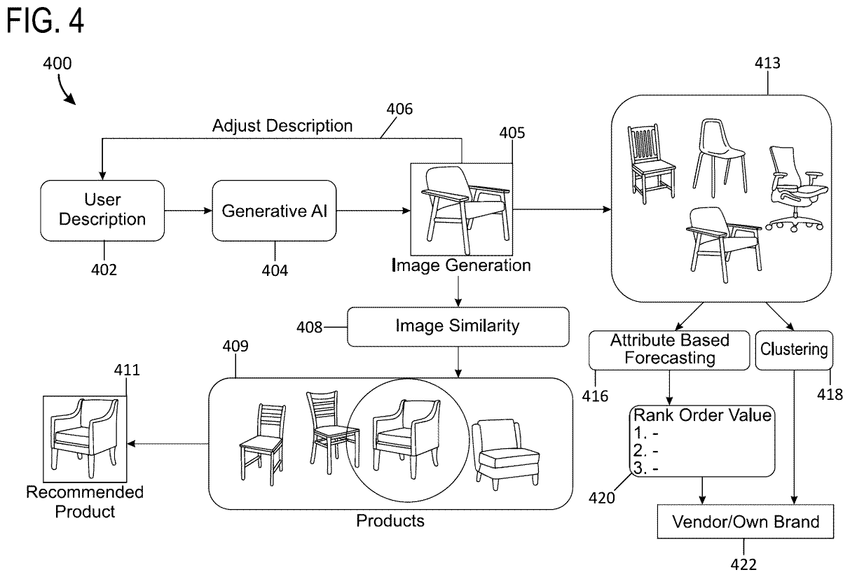

FIG. 4 illustrates a schematic diagram 400 of example aspects of the present disclosure. The diagram 400 includes aspects of components and operations described above in connection with the FIGS. 1-3. The diagram 400 includes some operations that may be performed during an example use of components described herein and includes some data, such as images, that may be generated as a result of the example use.

At operations 402, a user may input a description of an item to the AI image generator 106. The description may be, for example, “a sturdy lounging chair with armrests.” For example, the user may input the description to an item search field of a website or mobile application associated with a retailer or into an API that is provided by systems of the retailer, and backend systems of the retailer may route the description to the AI image generator 106.

At operation 404, the AI image generator 106 may generate the image 405 based on the user description and any other inputs that may be provided by the user. In some embodiments, the AI image generator 106 may generate a plurality of images, which may be returned to the user, and the user may select form the plurality of images.

At operation 406, the user may adjust a previous description. For example, the user may receive the image 405 and input an updated description to alter the image 405. The AI image generator 106 may then receive the updated description, and in some embodiments, the image 405, to generate a subsequent image. In this manner, the operation 402, 404, and 406 may be iteratively repeated as the user refines the image. Once the user is satisfied with the image, the user may elect (e.g., via a search engine feature offered by a retailer) to submit the image to a search engine. For the example of FIG. 4, the user may select to submit the image 405. Once the user has elected to search using the generated image 405, the image 405 may be submitted to a search engine 108 to perform an image similarity operation and to a collection of images 413, which may be part of the user-generated images 304.

At operation 408, the search engine 108 may compare the image 405 to images in the item catalog 110. The search engine 108 may identify one or more images that are most similar to the image 405, example aspects of which are described herein in connection with the search engine 108. Based on similarities between the image 405 and images of items in the item catalog 110, an item 411 may be selected (e.g., the circled chair). The selected item 411 is then recommended to a user. When provided to the user, the selected item 411 may include not only the image of the selected item 411, but also other details related to the selected item, such as its title, description, brand, ordering information, and other data associated with the item from the item catalog 110. Notably, the image of the selected item 411 may not be identical to the image 405, because the image 405, as an AI-generated image based on a user description, may not depict an actual product in the item catalog 110. However, the image of the selected item 411 may have been determined by the search engine 108 to be the most similar image to the image 405 from the images in the item catalog 110.

The images 413, which may include the image 405, may be part of the user-generated images 304 in the item design system 112. As shown, the images 413 may be examples of other images of chairs generated by the AI image generator 106 based on user descriptions. By using operations described, for example, in connection with FIG. 3, the item design system 112 may use the images 413 to generate design recommendations for chairs. For example, the item design system 112 may, using the attribute-based forecasting tool 310, perform an attribute-based forecasting operation 416 for attributes extracted from the images 413. As another example, the item design system 112 may use the clustering program 308 to perform a clustering operation 418 using the images 413.

At operation 420, the item design system 112 may use the ranking tool 314 to perform a rank order value operation 420 to rank attributes that are present in the images 413 based at least in part on data from the attribute-based forecasting operation 416. In the example shown, the item design system 112 may rank attributes based on the attribute-based forecasts alone. By ranking the attributes, the item design system 112 may identify attributes of chairs that may be worthwhile to consider for design recommendations. At operation 422, the clustering and the ranked attribute-based forecasts may be provided (e.g., as a recommendation for a new design) to a vendor or to an own-brand designer.

In accordance with example use cases of the system depicted in diagram 400, operation 422 may result in a recommendation for a new item design that is based on one or more of the images 413. The images 413 selected for generating a new item design may be images that are generated by users but for which no end purchase is made (indicating unmet need). In other examples, the images that are used may be selected based on clustering of images into attribute-specific image clusters, with frequency of images appearing in the images 413 being correlative to potential demand for a new item design.

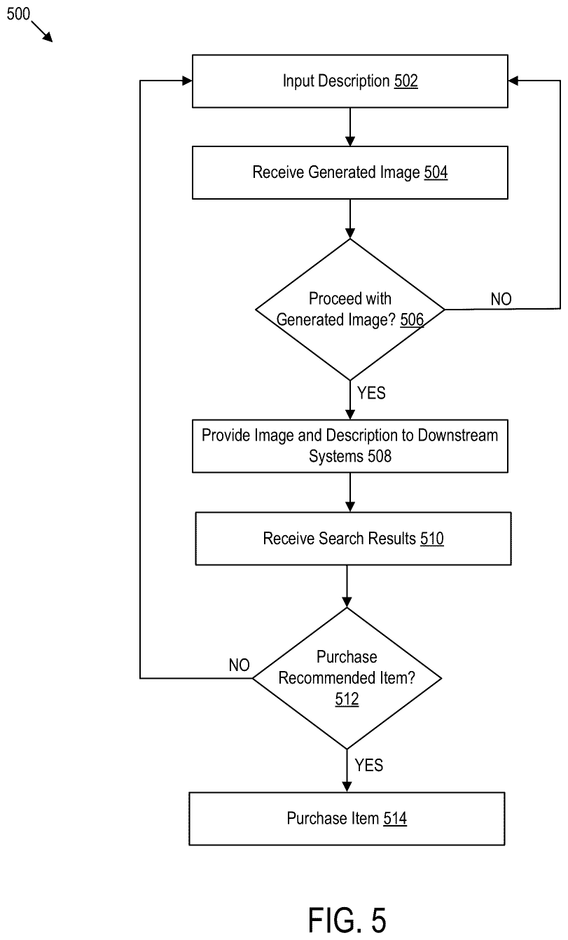

FIG. 5 is a flowchart of an example method 500. In the following description, operations of the method 500 are described as being performed by the user 102. However, depending on the embodiment, one or more of operations of the method 500 may be performed by multiple users, by a component of the information system 104, or by another component.

In the example shown, the user 102 may input a description of an item (step 502). For example, the user may, via an input field of a website or a mobile application associated with the information system 104, input a text string or voice query that describes an item for which the user is searching. In addition to the description, information related to the user may also be submitted (e.g., past user purchases, user preferences, biographical data, etc.). Furthermore, previous descriptions input by the user or previous images generated in response to previous user descriptions may, in addition to the description, be submitted to a component of the information system 104.

In the example shown, the user 102 may receive a generated image (step 504). The image may be based on the input description and be generated by the AI image generator 106. In some embodiments, the user 102 may receive a plurality of images generated based on the description. In some embodiments, the image may be displayed to the user 102 via a user interface having input fields via which the user input the image description.

In the example shown, the user 102 may determine whether to proceed with the received image (decision 506). On the one hand, the user 102 may determine that the received image is sufficiently represent of the item for which the user 102 is searching (e.g., taking the “YES” branch to the step 508). On the other hand, the user 102 may elect to edit the image prior to executing a search (e.g., taking the “NO” branch and returning to the step 504). For embodiments in which the user 102 may receive a plurality of images, the user 102 may determine whether to proceed with one or more of the received images. If so, the user 102 may select the one or more images and proceed to the step 508 using these images. If not, perhaps if the user 102 is not satisfied any of the plurality of returned images, the user 102 may return to the step 502. In some embodiments, the user 102 may simply input a new or updated description via an input field of the user interface when the user 102 elects not to proceed with the generated image.

In the example shown, the user 102 may provide the image and description to downstream systems (step 508). For example, the user 102 may provide the image and description to the search engine 108 and the item design system 112. In some instances, the image, and optionally the description, may be provided to downstream systems from the AI image generator on behalf of the user. In some instances, only the image may be provided to the downstream systems. In some embodiments, other data may also be provided to the downstream systems, such as previously generated images, previous descriptions, and user information, such as purchasing behavior, preferences, or other data. To provide the images to the downstream systems, the user 102 may, in some embodiments, select (e.g., touch or click) an option or button on a user interface (e.g., a search button).

In the example shown, the user 102 may receive search results (step 510). For example, the user 102 may receive one or more recommended items from an item catalog. The one or more recommended items may include images that are similar to the image submitted by the user 102. In some embodiments, the information system 104 may display a results user interface to the user 102 to display the search results. The results user interface may include, for example, the one or more items corresponding to images that are similar to the submitted image. The one or more items may be selected from an item catalog of a retailer, and may be items available for selection by the user 102.

In the example shown, the user 102 may determine whether to purchase a recommended item (decision 512). In response to electing to purchase one or more recommended items (e.g., taking the “YES” branch to the step 514), the user 102 may interact with a user interface component to add the one or more recommended items to a digital shopping cart and complete a purchase (step 514). In response to electing not to purchase any of the recommended items (e.g., taking the “NO” branch to the step 502), the user 102 may, in some instances, input a new description to repeat the search process and receive different recommended items.

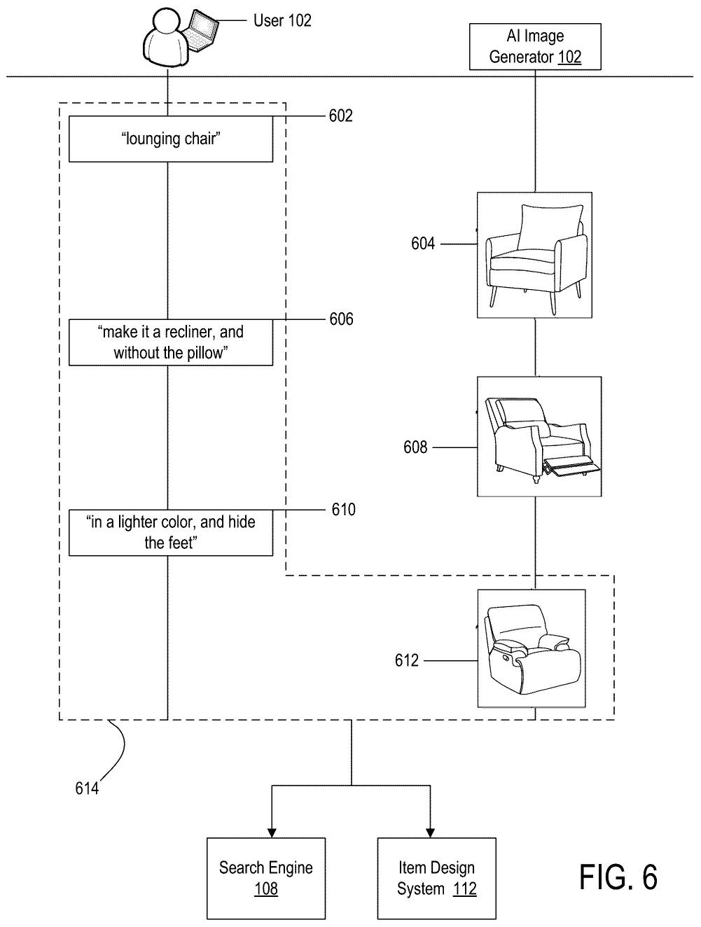

FIG. 6 illustrates example communications between the user 102 and the AI image generator 106. FIG. 6 illustrates an example of aspects of the steps 202-204 of FIG. 2 and the steps 502-506 of FIG. 5. As illustrated by the example of FIG. 6, the user 102 may iteratively update an item description in response to one or more images generated by the AI image generator 106 until receiving an image that looks like an item for which the user 102 is searching.

At step 602, the user 102 may input that they are looking for a “lounging chair.”

At step 604, the AI image generator 106 may generate and output an image of a lounging chair based, for example, on the user's input and other data received from the user 102 or other data about the user 102, such as the user's historical purchasing or searching activity.

At step 606, the user 102, perhaps not satisfied with the image of the lounging chair output by the AI image generator 106, may input the following description: “make it a recliner, and without the pillow.” As such, the user 102 may, in some embodiments, refer to a previously generated image as part of updating the search image, and the AI image generator 106 may generate a new image based on the previous image and the updated text description.

At step 608, the AI image generator 106 may generate an image of a lounging chair that reclines and without the pillow. To do so, the AI image generator 106 may use data stored in a memory (e.g., a cache) regarding previously generated images and previously input descriptions.

At step 610, the user 102, perhaps wanting to further alter the image output by the AI image generator 106, may input the following description: “in a lighter color, and hide the feet.”

At step 612, the AI image generator 106 may, according the user's updated description, generate and output the image of the lounging chair that reclines, does not have a pillow, is in a lighter color, and hides the feet.

Continuing with the example of FIG. 6, the user 102 may, sufficiently satisfied with the image output at the step 612, provide the image to downstream systems, such as the search engine 108 and the item design system 112. As illustrated by the dashed line, the user 102 may also, in some embodiments, provide not only the image to the downstream systems, but may also provide other data, such as one or more of the descriptions used to generate the image shown in connection with step 612. In some embodiments, the user 102 may also provide the previously generated images (e.g., at the steps 604 and 606) to the downstream systems.

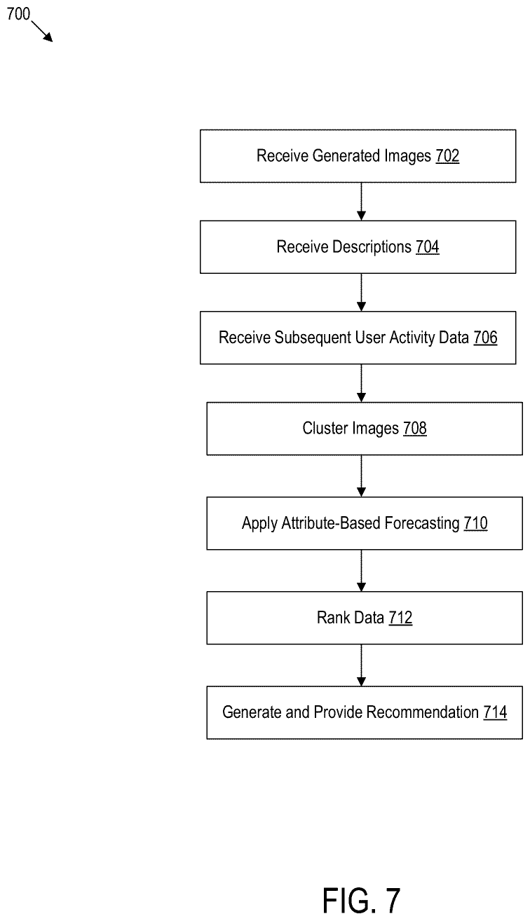

FIG. 7 is a flowchart of a method 700. In the following description, operations of the method 700 are described as being performed by the item design system 112. In some embodiments, operations of the method 700 may be performed by one or more components of the item design system 112 described in connection with FIG. 3. However, depending on the embodiment, one or more operations of the method 700 may be performed by a different component of the information system 104 or by a different system.

In the example shown, the item design system 112 may receive generated images (step 702). For example, the item design system 112 may receive images generated by the AI image generator 106 based on descriptions entered by users.

In the example shown, the item design system 112 may receive descriptions (step 704). The descriptions may be the text input by users to the AI image generator 106 to generate the images. In some embodiments, the item design system 112 may receive the generated images and the text used to generate the images at the same time.

In the example shown, the item design system 112 may receive subsequent user activity data (step 706). The subsequent user activity data may be, for example, the purchasing data 316 described above in connection with FIG. 3, which may indicate whether users purchased recommended items that were presented in response to the image similarity processes described herein. The subsequent user activity data may also include other user interactions with frontend systems of the information system 104 (e.g., browsing activity, subsequent searching activity, and the like).

In the example shown, the item design system 112 may cluster images (step 708). An example of clustering images is described above in connection with the clustering program 308 of FIG. 3.

In the example shown, the item design system 112 may apply attribute-based forecasting (step 710). An example of attribute-based forecasting is described above in connection with the attribute-based forecasting tool 310 of FIG. 3.

In the example shown, the item design system 112 may rank data (step 712). For example, the item design system 112 may, based on both the images generated for items and based on forecasted demand data, rank attributes of items. An example of ranking data is described above in connection with the ranking tool 314 of FIG. 3.

In the example shown, the item design system 112 may generate and provide recommendations (step 714). An example of generating and providing recommendations is described above in connection with the recommendation generator 318 of FIG. 3.

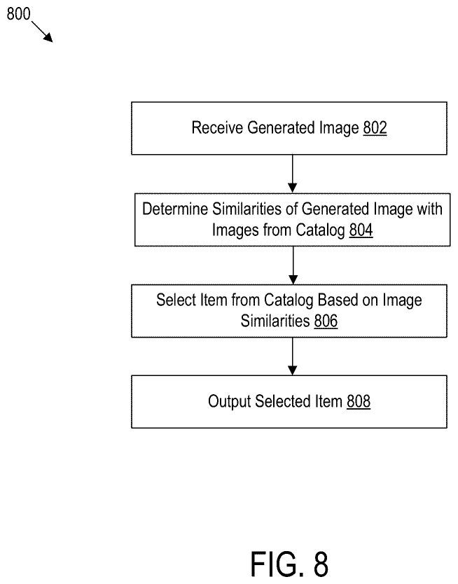

FIG. 8 is a flowchart of an example method 800. In the following description, operations of the method 800 are described as being performed by the search engine 108. However, depending on the embodiments, one or more operations of the method 800 may be performed by a different component of the information system 104 or a different system.

In the example shown, the search engine 108 may receive a generated image (step 802). For example, the user 102, or another component or entity, may submit an image generated by the AI image generator 106 to the search engine 108. In some embodiments, the search engine 108 may receive a plurality of images (e.g., the user 102 may search for an item using multiple images or a combination of images generated by the AI image generator 106).

In the example shown, the search engine 108 may determine similarities of the received generated image with a plurality of images in an item catalog (step 804). An example of determining similarities between the generated image and images from an item catalog is described above in connection with the step 210 of FIG. 2 and in connection with the search engine 108 of FIG. 1.

In the example shown, the search engine 108 may select a number of items from the item catalog based on the similarities of the items with the generated image (step 806). Depending on the embodiment, the search engine 108 may select one item, two items, five items, ten items, or any number of items based on the similarity of their images with the generated image. In some embodiments, such as when an image-comparison process outputs a numerical representation of similarity, the search engine 108 may select the items associated with the highest (or lowest) similarity number.

In the example shown, the search engine 108 may output the selected one or more items (step 808). For example, the search engine 108 may recommend the one or more selected items to a user via a website.

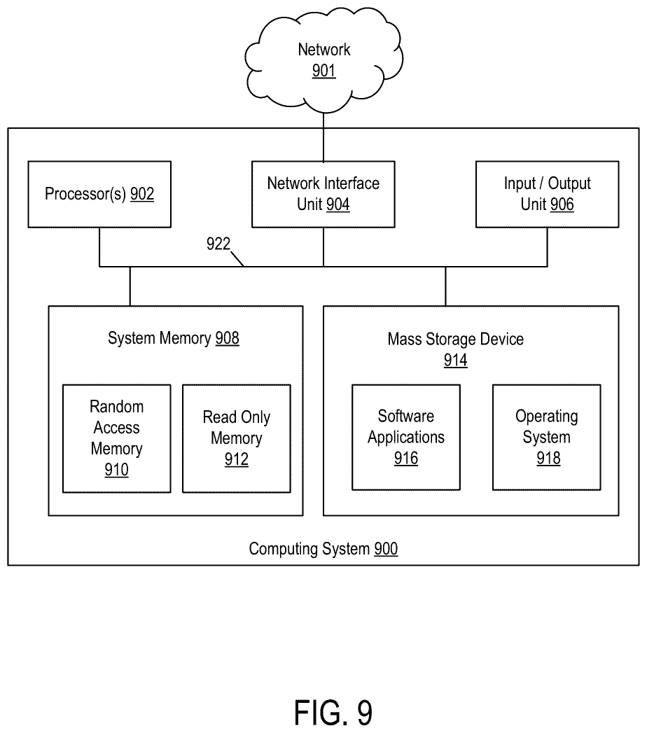

FIG. 9 illustrates an example block diagram of a computing system 900. One or more aspects of the computing system 900 can be used to implement the system and processes described herein.

In the embodiment shown, the computing system 900 includes one or more processors 902, a system memory 908, and a system bus 922 that couples the system memory 908 to the one or more processors 902. The system memory 908 includes RAM (Random Access Memory) 910 and ROM (Read-Only Memory) 912. A basic input/output system that contains the basic routines that help to transfer information between elements within the computing system 900, such as during startup, is stored in the ROM 912. The computing system 900 further includes a mass storage device 914. The mass storage device 914 is able to store software instructions and data. The one or more processors 902 can be one or more central processing units or other processors.

The mass storage device 914 is connected to the one or more processors 902 through a mass storage controller (not shown) connected to the system bus 922. The mass storage device 914 and its associated computer-readable data storage media provide non-volatile, non-transitory storage for the computing system 900. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 900.

According to various embodiments of the invention, the computing system 900 may operate in a networked environment using logical connections to remote network devices through the network 901. The network 901 is a computer network, such as an enterprise intranet and/or the Internet. The network 901 can include a LAN, a Wide Area Network (WAN), the Internet, wireless transmission mediums, wired transmission mediums, other networks, and combinations thereof. The computing system 900 may connect to the network 901 through a network interface unit 904 connected to the system bus 922. It should be appreciated that the network interface unit 904 may also be utilized to connect to other types of networks and remote computing systems. The computing system 900 also includes an input/output controller 906 for receiving and processing input from a number of other devices, including a touch user interface display screen, or another type of input device. Similarly, the input/output controller 906 may provide output to a touch user interface display screen or other type of output device.

As mentioned briefly above, the mass storage device 914 and the RAM 910 of the computing system 900 can store software instructions and data. The software instructions can include an operating system 918 suitable for controlling the operation of the computing system 900. The mass storage device 914 and/or the RAM 910 also store software instructions 916, that when executed by the one or more processors 902, cause one or more of the systems, devices, or components described herein to provide functionality described herein. For example, the mass storage device 914 and/or the RAM 910 can store software instructions that, when executed by the one or more processors 902, cause the computing system 900 to implement a browser or mobile application when implemented as a mobile device of a user 102, or may otherwise cause the computing system 900 to implement one or more computing systems of a system for using AI-generated images for item recommendation generation and new item design in accordance with the methods and systems described herein.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A method for using artificial intelligence (AI)-generated images to search an item catalog, the method comprising:
providing a text description of an item to an application programming interface (API) of an AI image generator to generate an item image;
receiving the item image from the AI image generator;
applying a machine learning model to the item image to generate embeddings for the item image;
generating a plurality of similarity scores by comparing the embeddings for the item image to a plurality of pre-computed embeddings derived from a plurality of images of items in the item catalog;
based on the plurality of similarity scores, selecting a similar image from the plurality of images; and
from the item catalog, selecting an item corresponding to the similar image.

2. The method of claim 1, further comprising:
receiving the text description of the item from a user via a text input field of an item search feature of a retail website; and
recommending the selected item to the user by displaying, via a user interface of the retail website, the similar image and the selected item.

3. The method of claim 1, further comprising, prior to applying the machine learning model to the item image to generate the embeddings for the item image:
providing the item image to a user;
receiving an updated item description from the user; and
providing the updated item description to the API of the AI image generator to update the item image.

4. The method of claim 1, further comprising:
automatically providing the item image to an item design system; and
generating, at the item design system, a recommendation for an item design based at least in part on the item image.

5. The method of claim 4, further comprising determining, at the item design system, an attribute-based demand forecast for an attribute identified in the item image.

6. The method of claim 5, wherein the recommendation for the item design is based at least in part on a clustering of the item image with a plurality of generated images and on the attribute-based demand forecast for the attribute identified in the item image.

7. The method of claim 4,
further comprising determining that a user did not purchase the selected item; and
wherein generating, at the item design system, the recommendation for the item design is performed in response to determining that the user did not purchase the selected item.

8. The method of claim 1, further comprising:
providing a plurality of text descriptions received from a plurality of users to the API of the AI image generator to generate a plurality of item images;
receiving the plurality of item images from the AI image generator;
providing the plurality of item images to an item design system;
clustering, at the item design system, the plurality of item images to generate a plurality of clusters; and
based on a characteristic of one of the plurality of clusters, generate an item design recommendation.

9. The method of claim 1,
providing a plurality of text descriptions received from a plurality of users to the API of the AI image generator to generate a plurality of item images;
receiving the plurality of item images from the AI image generator;
providing the plurality of item images to an item design system;
identifying, at the item design system, a first attribute in a first image of the plurality of item images;
identifying, at the item design system, a second attribute in a second image of the plurality of item images; and
generating an item design recommendation by combining the first attribute and the second attribute.

10. The method of claim 1, further comprising iteratively updating the item image, wherein iteratively updating the item image comprises repeatedly performing:
providing the item image to a user;
providing the item image to an item design system;
receiving an updated text description of the item from the user;
providing the updated text description and the item image to the API of the AI image generator to update the item image; and
receiving the item image from the AI image generator after the AI image generator updates the item image based at least in part on the updated text description.

11. A system for using artificial intelligence (AI)-generated images to search an item catalog, the system comprising:
a processor; and
memory storing instructions that, when executed by the processor, cause the system to:
provide a text description of an item to an application programming interface (API) of an AI image generator to generate an item image;
receive the item image from the AI image generator;
provide the item image to an item design system;
apply a machine learning model to compare the item image to a plurality of images of items in the item catalog;
from the plurality of images of items in the item catalog, identify a similar image to the item image;
from the item catalog, select an item corresponding to the similar image; and
provide data corresponding to the selected item to a user.

12. The system of claim 11, wherein the item design system is configured to:
receive the item image and the text description;
store the item image in a collection of images generated by the AI image generator;
store the text description in a collection of image descriptions;
analyze the collection of images and the collection of image descriptions; and
based on the analysis of the collection of images and the collection of image descriptions, generate an item design recommendation.

13. The system of claim 11, wherein the item design system is configured to:
cluster the item image with a plurality of generated images;
determine an attribute-based demand forecast using the item image; and
generate an item design recommendation based at least in part on clustering the image with the plurality of generated images and the attribute-based demand forecast using the image.

14. The system of claim 13, wherein the item design system is configured to cluster the item image with the plurality of generated images based, at least in part, on image similarity between the item image and each of the plurality of generated images.

15. The system of claim 14, wherein the item design system is configured to cluster the item image with the plurality of generated images further based on a similarity between the text description and text used to generate the plurality of generated images.

16. The system of claim 11,
further comprising the AI image generator, the item design system, and a search engine;
wherein the search engine is configured to:
apply the machine learning model to compare the item image to the plurality of images of items in the item catalog; and
from the plurality of images of items in the item catalog, identify the similar image to the item image.

17. The system of claim 16, wherein the search engine is included within a retail website.

18. The system of claim 11,
wherein identifying the similar image to the item image comprises identifying a plurality of similar images to the item image;
wherein selecting the item corresponding to the similar image comprises selecting a plurality of items; and
wherein providing data corresponding to the selected item to the user comprises providing data for each item of the plurality of selected items to the user.

19. A website including an item search feature, the website comprising:
a processor; and
memory storing instructions that, when executed by the processor, cause the website to:
receive a text description of an item via a text input field of a user interface;
provide the text description to an AI image generator to generate an item image;
receive the item image from the AI image generator;
apply a machine learning model to the item image to generate embeddings for the item image;
generate a plurality of similarity scores by comparing the embeddings for the item image to a plurality of pre-computed embeddings derived from a plurality of images of items in the item catalog;
based on the plurality of similarity scores, select a similar image from the plurality of images; and
from an item catalog, select an item corresponding to the similar image.

20. The website of claim 19, wherein the instructions, when executed by the processor, further cause the website to display the item corresponding to the similar image via the user interface.
